(19) United States
(12) Patent Application Publication
(10) Pub. No.: US 2015/0142540 A1
(43) Pub. Date: May 21, 2015

(54) APPLICATION PROVIDING SYSTEM WITH REWARD PROVIDING FUNCTION

(71) Applicant: YYY NET CO., LTD., Tokyo (JP)

(72) Inventor: Fumitaka OKAMOTO, Tokyo (JP)

(21) Appl. No.: 14/520,582

(22) Filed: Oct. 22, 2014

(30) Foreign Application Priority Data
Nov. 21, 2013 (JP) 240816/2013
Jul. 9, 2014 (JP) 141180/2014

(51) Int. Cl. G06Q 30/02; H04L 29/08

(52) U.S. Cl. CPC G06Q 30/0214; H04L 67/10
USPC 705/14.16

(57) ABSTRACT

A server system has a storage unit for storing user information of registered users, including at least one of a mail address and telephone number of each registered user. A contact information obtaining unit obtains a contact information list of users that are currently registered as friends in the registered user terminal. When a searching unit determined that some of friend users on the obtained contact information list have been registered as registered users in the storage unit, an inviter candidate list generation unit generates an inviter candidate list containing the friend users registered as registered users and contact information thereof, and supplies the list to the user terminal in which the application was just installed. An inviter specifying unit specifies an inviter and stores the inviter in the storage unit. A reward updating unit updates a reward of the inviter specified by the inviter specifying unit.

### TECHNICAL FIELD

The invention relates to an application providing system, and m more detail, to a system for providing an application such as a game or the like to a registered users cm a network, in which the system, can provide a reward to an introducer (or an inviter) when he or she introduces a friend or the like (or an invitee) to the application providing system.

### BACKGROUND ART

Some of applications, such as on-line games and so on that run on user terminals such as smart phones employing Android®, smart phones named iPhone®, tablet terminals and so on, adopt a system for providing a user registered with a platform of an application with rewards such as an item, a point and so on, when he or she succeeds introduction of the application to a friend or the like. That is, when the user introduces the application to the friend or the like, and the friend then uses the application, the user can obtain a reward as an introducer (or inviter) and the friend is an introduced person for invitee). In such a system, it is common to use a method in which a user that wishes to introduce a friend or the like to a server system which can provide such an application, registers an invitation code (invitation ID) of the user with the server system in advance, and the user requests the friend to enter the invitation ID when the friend accesses the server system, to thereby associate the friend as an invitee with the user as an inviter.

In an application providing system having a function that a reward is provided to an inviter when an invitee uses an application according to the prior art above, the following problems exist.

It is necessary for an invitee such as a friend (or an introduced person) to enter an invitation code of an inviter (or a registered user) to a platform of an application when the friend wishes to register to it, and such a procedure is bothersome. Especially, in some smart phones, it is difficult to carry out a copy and paste operation, and therefore, the friend needs to enter the invitation code using keyboards on his or her smart phone.

Further, the inviter must contact the friend or invitee and provide he/her with a recommendation comment such as “I recommend you playing the ## game. If you don't mind, please enter the invitation code ######,” orally or via a communication network; and, at that time, the inviter's intention that he/she is recommending the game to the friend for obtaining a reward, may be exposed. Still further, the friend may feel that the inviter is wishing the friend to help him/her, rather than that he/she is recommending the game to the friend because it is fun. Thus, the inviter may feel that he/she may owe the friend something, and hesitate to introduce the game to the friend.

Some examples that do not use the invitation code system described above are mobage (R), GREE (R), LINE (R) and so on. In each of these systems, since users within its platform are already associated with each other, it is unnecessary to use an invitation code, and it is possible to invite a friend within the platform by use of an internal mini-mail and/or a chat message. However, when inviting a friend external to the platform, it is necessary to recommend the friend to newly register him/her with the platform. In such a case, it is required to carry out two procedures, i.e., a procedure for recommending new registration and a procedure for introducing an application such as a game or the like after completion of the new registration procedure. Further, even in the case that a user within the platform is to be invited, if an invitee (or introduced person) is led to an application, by a mini mail or a chat and if the invitee then starts using the application, the inviter (or introducer) and the invitee are automatically specified; thus, the inviter feels that the invitee may consider that the invitee is invited for “the benefit of the inviter such, as for the purpose of obtaining rewards for the inviter” and, accordingly, the inviter may hesitate to carrying out an introduction activity.

### SUMMARY OF INVENTION

The present invention has been accomplished to solve the forgoing problems of the prior arts, and the object of the invention is to provide an application providing system in which when a friend newly registers itself with the system, and then if he/she starts using the application, it is determined that invitation for the application by a registered user to the friend has been successfully concluded, without entering an invitation code of the registered user by the friend.

To achieve the object, the invention provides an application providing system for providing an application on a network, comprising a server system for providing a registered user as an inviter with a reward when an invitee is newly registered with the server system or starts using the application provided, wherein the server system comprises:

a storage unit for storing, in association with each of registered users of the application providing system, user information of invitee candidates of registered users, the user information including contact information of the invitee candidates;

a registration accepting unit for accepting registration of a new user;

a search unit for searching, when the registration of the new user has been accepted, whether user information of the new user exists in the storage unit as an invitee candidate, and, if so, searching registered users associated with the searched invitee candidate from the storage unit to set the searched registered users to be inviter candidates;

a list generation unit for generating a list of the inviter candidates obtained by the search unit, and supplying the inviter candidate list to a terminal of the new user;

an inviter specifying unit for specifying an inviter which has been selected from the inviter candidate list by the new user and transmitted from its terminal, and storing the inviter in the storage unit in association with the new user that is the invitee; and

a reward updating unit for updating a reward of the inviter specified by the inviter specifying unit, by adding a reward for a successfully concluded invitation, to a previous reward of the inviter.

In an embodiment of the application providing system, according to the invention, the registration accepting unit of the server system further comprises means for providing the terminal of the new user with an entry page or box for entering an invitee candidate at the time of registration of the new user, and means for associating the entered invitee candidate with the new user and storing in the storage unit, the entered invitee candidate in association with the new user.

In another embodiment of the application providing system according to the invention, the server system further comprises contact information obtaining unit for obtaining contact information of users which are currently registered in the new user's terminal and/or contained in a communication history in the new user's terminal, when the application is installed in the new user's terminal, and storing in the storage unit, the obtained users with their contact information as invitee candidates of the new user. In this embodiment, the server system may further comprise an authentication unit adapted to authenticate a user, wherein the registration accepting unit is further adapted to display an entry page or box on the new user's terminal for entering an ID of an SNS, and the contact information obtaining unit is further adapted to operate in such a manner that if the SNS_ID is inputted and authenticated by the authentication unit, users having friend IDs associated with the SNS_ID and their contact information are obtained from the SNS, and the obtained users having the friend IDs with their contact information are stored in the storage unit as invitee candidates.

To achieve the above object, the invention provides a second application providing system for providing an application on a network, comprising a server system for providing a registered user as an inviter with a reward when the application is installed in a newly registered user terminal or the newly registered user satisfies a predetermined condition using the installed application, wherein the server system comprises:

a storage unit for storing, in association with each of registered users of the application providing system, user information including at least one of mail address and telephone number of each registered user;

a registration accepting unit for accepting registration of a new user;

a contact information obtaining unit for obtaining from a registered user terminal, after the application is installed in the registered user terminal, a contact information list of users those are currently registered as friends in the registered user terminal, the contact information list containing email addresses or telephone numbers of the friends;

a searching unit for searching whether each of the friend users on the obtained contact information list has been registered as a registered user in the storage unit;

means for generating a list of inviter candidates in responding to the search result by the searching unit, if a friend user(s) on the contact information list has been registered as a registered user in the storage unit, wherein the inviter candidate list contains the friend user(s) that has been registered as a registered user(s) and contact information thereof, and supplying the inviter candidate list to the user terminal in which the application has been installed;

an inviter specifying unit for specifying an inviter which has been selected from the inviter candidate list by the user and transmitted from its terminal, and storing the inviter in the storage unit in association with the user who is the invitee; and

means for updating a reward, of the inviter specified by the inviter specifying unit, by adding a reward for a successfully concluded introduction to a previous reward of the inviter, when the application is installed in the newly registered user terminal or the newly registered user satisfies a predetermined condition using the installed application. The predetermined condition may be an initial use or tutorial completion of the application after installing it.

In an embodiment of the second application providing system according to the invention, the contact information obtaining unit is further adapted to obtain, in addition to the first contact information list of the friend users currently registered in the user terminal when installing the application therein, a second contact information list of users contained in a communication history in the user terminal. The searching unit searches whether each of the friend users on the obtained first, and second contact information lists has been registered as a registered user in the storage unit.

In another embodiment of the second application system according to the invention, the server system further comprises an authentication unit adapted to authenticate a user, and to display an entry box or page on the user terminal for entering an ID of an SNS, and the contact information obtaining unit is further adapted to process in such a manner that when the SNS_ID is inputted and authenticated by the authentication unit, users having friend IDs associated with the SNS_ID and their contact information are obtained from the SNS, and the obtained users having the friend IDs with their contact information are stored in the storage unit as inviter candidates.

The invention further provides a user terminal comprising the application provided by the server system of the application providing system of the second embodiment, wherein the application comprises a computer program embedded therein, by which the contact information list of users those are currently registered as friends in the user terminal, is read out and forwarded from the user terminal to the contact information list obtaining unit of the server system.

### BRIEF DESCRIPTION OF DRAWINGS

FIG. 1 is a general explanatory drawing illustrating a first embodiment of an application providing system on a communication network, in which a reward is provided to an inviter (or introducer), according to the invention;

FIGS. 2A and 2B are schematic diagrams for explaining data and updated data in user information database of a server system of the application providing system shown in FIG. 1;

FIG. 3 shows a flowchart for explaining processes carried out at the time of user registration in the application providing system illustrated in FIG. 1;

FIG. 4 is a general explanatory drawing illustrating a second embodiment of an application providing system on a communication network, in which a reward is provided to an inviter (or introducer), according to the invention;

FIGS. 5A and 5B are schematic diagrams for explaining data and updated data in user information database of a server system of the application providing system shown in FIG. 4; and

FIG. 6 shows a flowchart for explaining processes carried out at the time of user registration in the application providing system illustrated in FIG. 4.

### DESCRIPTION Of EMBODIMENTS

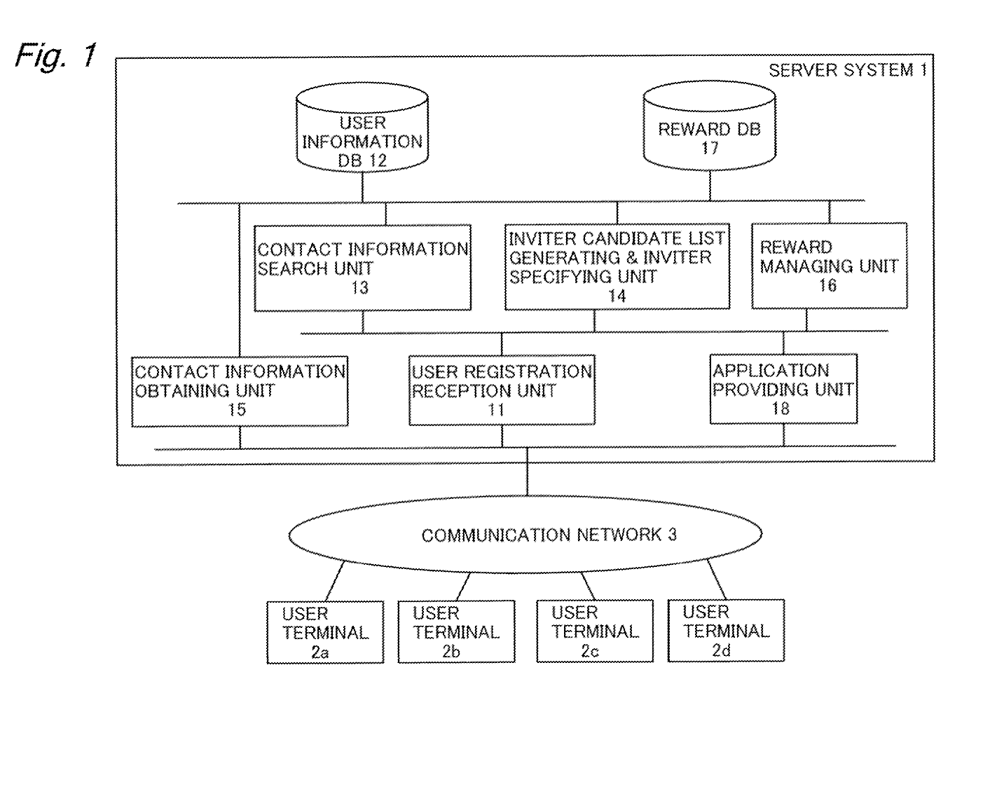

FIG. 1 schematically shows a first embodiment of an application providing system according to the invention, which comprises a server system with a reward providing function. In FIG. 1, the reference numeral 1 denotes the server system for managing an application and reword providing, 2 (or 2a, 2b, 2c, 2d exemplified in FIG. 1) a user terminal such as a smart phone, a tablet terminal or the like, and 3 a communication network. Each user terminal 2 is coupled to the communication network 3 in a wired and/or wireless manner, and can communicate with other user terminals 2 and the server system 1 through the communication network 3.

The server system 1 comprises a plurality of computer program units including a user registration reception unit 11, a contact information search unit 13, an inviter candidate list generating/inviter specifying unit 14, a contact information obtaining unit 15, a reward managing unit 16, and an application providing unit 18. The server system 1 further comprises user information database (DB) 12 and reward DB 17. The DB 12 and DB 17 can be constructed as one database.

The user registration reception unit 11 has a function to receive from a user terminal 2 a new registration request of an unregistered user, and displays an entry window for user registration on the user terminal 2. On the user registration entry window, at least boxes for entering a user's name, a mail address, and a telephone number are provided.

The user information DB 12 stores contact information (i.e., at least, one of a mail address and a telephone number) of each registered user that has been registered through the user registration reception unit 11, in association with a user name (or user ID); and also stores contact information of each of users who may become invitee candidates or persons to be introduced by each registered user, and contact information of each inviter (or introducer). The contact information of the invitee candidate is automatically obtained from a user terminal of a registered, user by the contact information obtaining unit 15. The contact information can be also obtained from the user terminal 2 by letting the user enter such information at the time of registration of the user in the application providing system. The obtainment of the contact information will be explained below in more detail.

The inviter candidate list generating/inviter specifying unit 14 judges, when a registration request from a new user is received at the user registration reception unit 11, whether the contact information of the new user exists in the user information DB 12 as an invitee candidate, based on the information searched by the contact information search unit 13. If the contact information of the new user exists therein, the unit 14 generates an inviter candidate list and renders the user registration, reception unit 11 to display it on the user terminal of the newly registered user. The inviter candidate list contains names of registered users as inviter candidates those are associated with the newly registered user. Thereafter, when the newly registered user selects an inviter from the inviter candidate list, the selected inviter is stored in the contact information DB 12 in association with the newly registered user.

The contact information obtaining unit 15 obtains, from the user terminal 2 of the registered user, contact information including other users and their telephone numbers, email addresses and so on currently registered in the registered user terminal; and stores, in association with the registered user, the obtained other users with their contact information as invitee candidates in the user information DB 12. The forgoing process for obtaining the contact information of the other users can be carried out by incorporating in an application to be installed in the registered user terminal, a function for automatically extracting the other users' contact information registered in telephone directories or the like of the registered users' terminals and automatically transmitting the extracted contact information to the contact information obtaining unit 15, after installing the application in the registered user terminal. In addition, if a history of past communication by email and telephone remains in the registered user terminal and if the communication history can be read from it (for example, in the case of a smart phone), the contact information contained in the communication history is also extracted and transmitted to the contact information obtaining unit 15 after installing the application. The transmitted information is also stored as invitee candidates in association with the registered user in the user information DB 12. Invitee candidates may be entered by a user on an entry window of the user terminal provided by the user registration reception unit 11, or they may be obtained by both of the user-entering operation and the automatic obtaining operation.

The reward managing unit 16 calculates a reward such as a point and so on to be given to a registered user, and stores the calculation result in the reward DB 17 in association with the registered user. The reward for each registered user is updated when a relationship between a inviter and its invitee is settled under conditions that a user stored in the user information DB 12 as an invitee candidate of the registered user is newly registered with the server system 1, and then the application is installed in a user terminal of the newly registered user, or the application is initially utilized, or tutorial of the application is completed. Even if the above conditions are satisfied, it may be possible to postpone addition of the reward for successfully terminated introduction to the inviter until a certain condition is satisfied, for example, until the invitee proceeds to a predetermined level “Level #” after complete provision of the tutorial and thereafter, add the reward for successfully terminated introduction between the inviter and the invitee. Also, it is possible to give a reward (or an invitee reward) to the invitee.

The application providing unit 18 provides the application to a registered user terminal 2 when the user accesses the server system 1 to use the application, so that the application can be installed in the registered user terminal.

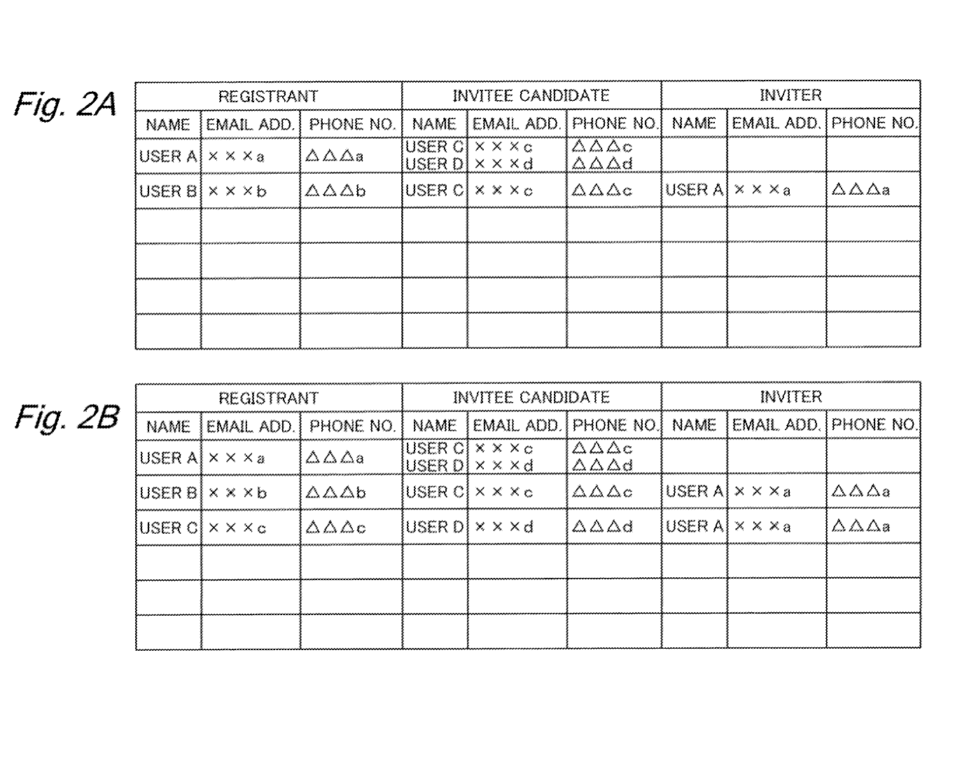

FIG. 2A is an explanatory diagram for explaining information stored in the contact information DB 12. In the example shown in FIG. 2A, the user terminals 2a and 2b (in FIG. 1) are of users A and B those have been registered with the server system 1, and that the user terminals 2e and 2d (in FIG. 1) are users C and D those have not yet been registered with the server system 1. In addition, it is assumed that invitee candidates of the user A is the users C and D, the invitee candidate of the user B is the user C, and the inviter of the user B is the user A.

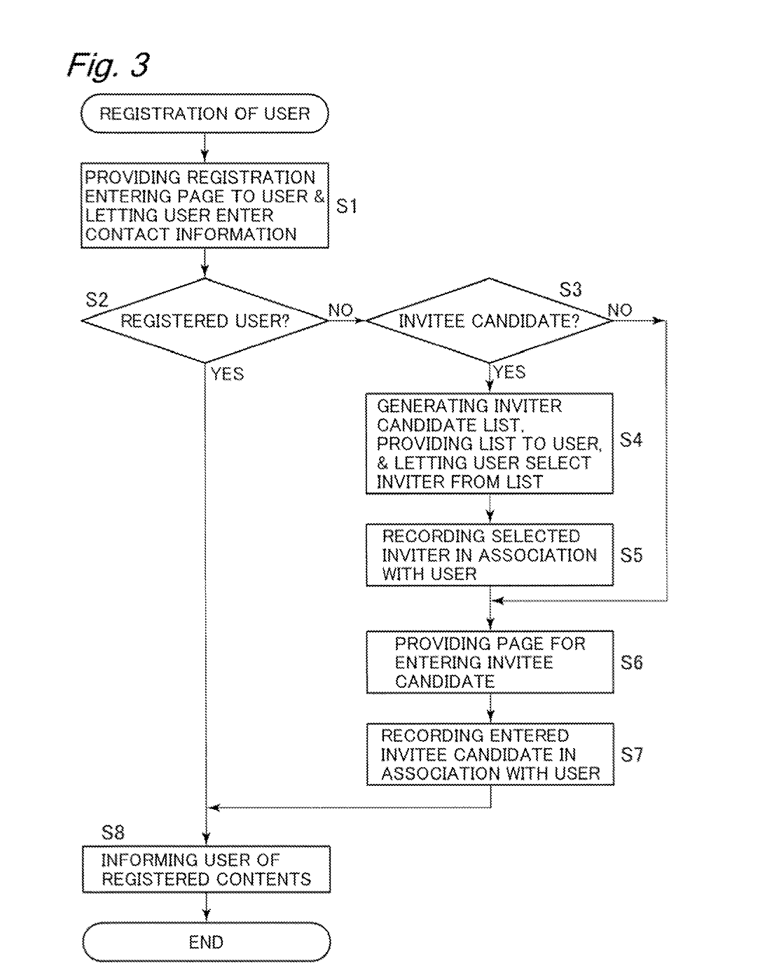

A user registration operation under the condition that the data recorded in the user information DB 12 is illustrated in FIG. 2A, will be explained with reference to FIG. 3.

For example, it is assumed that the unregistered user C wishes to use the application provided by the server system 1 and accordingly accesses the server system 1 from the user terminal 2e. In response to the access, the user registration reception unit 11 of the server system 1 provides the user terminal 2c with an entry page to be used for user registration at Step S1. When the user C enters contact information of the user C on the entry page of the user terminal 2c, the contact information search unit 13 carries out a search of the user information DB 12 to judge at Step S2 whether the user C of the terminal 2c is a registered user. In this example, since the user C is not registered, the operation, goes from Step S2 to Step S3, where the contact information search unit 13 searches the user information DB 12 and judges whether the unregistered user C is recorded as an invitee candidate, i.e., whether a registered user terminal that has the user C as an invitee candidate in the candidate field of the DB 12, exists.

If exists, at Step S4, the inviter candidate list generating/inviter specifying unit 14 generates an inviter candidate list, based on the result of the search carried out by the contact information search unit 13. In this example, since each of the user terminals 2a and 2b records the user terminal 2c as an invitee candidate, the inviter candidate list generated by the unit 14 contains the name of the users A and B with the contact information of the user terminals 2a and 2b. The generated list is supplied, to the user terminal 2c via the user registration reception unit 11. At the user terminal 2c, one inviter is selected from the inviter candidate list by the user C. For example, if only the user A of the user terminal 2a is selected, the inviter candidate list generating/inviter specifying unit 14 associates the user A as an inviter with the user C, and stores the relationship in the user information DB 12 at Step S5. It may be possible to allow a newly registered user to select no inviter and/or select plural or all inviters from the inviter candidate list.

Next, at Step S6, the user registration reception part 11 displays, on the user terminal 2c, an entry window that prompts for entering of contact information of a terminal of a member or user that the user C wishes to register as an invitee candidate, if any. Then at Step S7, contact information entered via the entry window is associated, as contact information of an invitee candidate, with the user C and stored the information in the DB 12. For example, if the user C enters the user D as an invitee candidate, the data of the DB 12 is updated as shown in FIG. 2B. It is possible to use a mail address of a free-mail, a telephone number of a fixed-line phone or the like as contact information of an invitee candidate. The process goes from Step S7 to Step S8, where the registered contents of the user C are communicated to the terminal 2c for the confirmation.

When the user C has been registered with the server system 1 and an application is thereafter transmitted from the application providing unit 18 to the user terminal 2c, the reward managing unit 16 updates a reward of the user A (who is selected by the user C from the inviter candidate list) stored in the reward DB 17, by adding an invitation reward for successfully concluded introduction to the reward currently stored in the DB 17. As explained above, it is also possible to give an invitee reward to the user C who has been registered. In the case that a plurality of inviters exist in the inviter candidate list and that a newly registered user is allowed to select two or more inviters (or all of the inviters) from the list, the invitation reward, that is to be given after a successful conclusion of the invitation, is divided among inviters selected by an invitee.

On the other hand, in the case that the user registration page is accessed by the user A of the terminal 2a (or the user B of the terminal 2b), the result of determination carried out at Step S2 indicates “YES,” because the user A (or B) has been registered, and therefore, the process proceeds from Step S2 to Step S8. At Step S8, the registered contents of the user A (or B) are communicated to the terminal 2a (or 2b) for the confirmation. If necessary, the registered contents may be modified by the user A (or B).

In the case that the user registration page is accessed by the unregistered user D of the terminal 2d, the process proceeds from Step S2 via Step S3 to Step S4. Since the user A is the only registered user that is associated with the user D as an invitee candidate, as illustrated in FIG. 2A, only the user A is listed in the inviter candidate list generated at Step S4.

Further, if the user registration page is accessed by an unregistered user X, and if the user X is not registered as an invitee candidate in the DB 12, the process jumps from Step S3 to Step S6, where the window for entering contact information of a user(s) that the user X wishes to register as an invitee candidate(s) is displayed on the user X's terminal, and, at Step S7, the entered contact information of the invitee candidate is associated with the user X and stored in the DB 12, as explained above.

After completing Step S8, the user registration process terminates.

In the application providing system illustrated in FIG. 1, the user registration process is basically carried out before the application is installed in a user terminal, and the contact information of friends obtained from the telephone/email, directory stored in the user terminal, is stored in the user information DB 12 as an invitee candidate. Alternatively, it is possible to obtain such contact information of friends of a newly registered user after installing an application in his/her user terminal, and not to store the contact information as invitee candidates. In the alternative system, contact information of each friend stored in a telephone/email directory of the user terminal where the application has been just installed, is obtained and compared with the registered users in the DB 12, and lists each friend that coincides with one of the registered users on an inviter candidate list, which is provided to the user terminal thereafter.

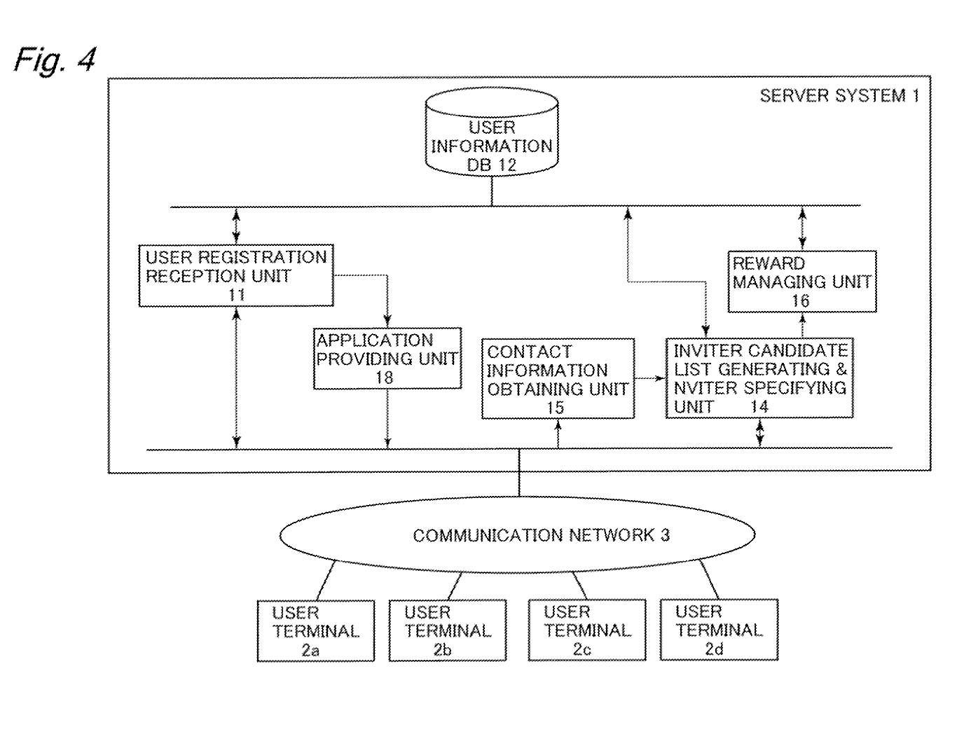

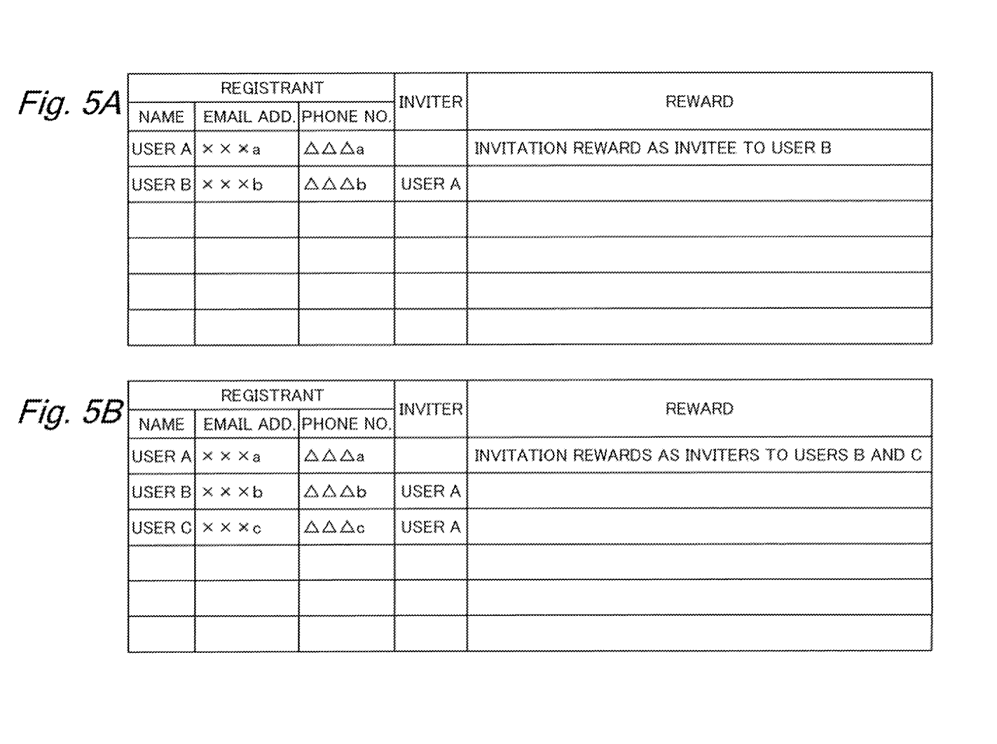

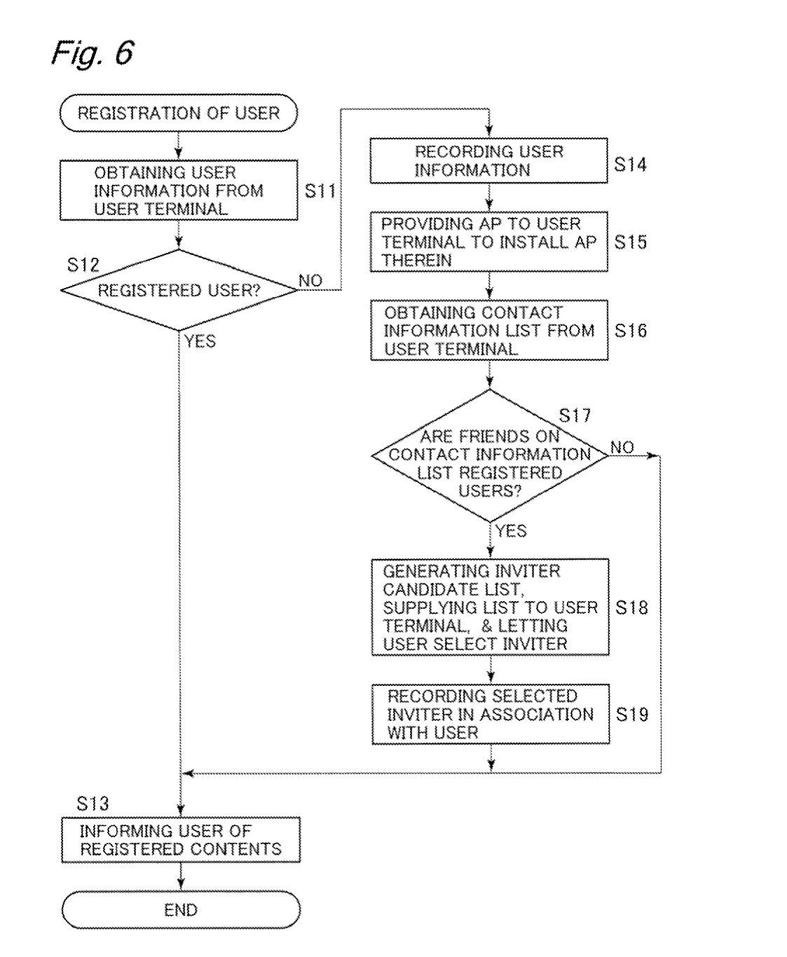

Such an alternative application providing system is shown in FIG. 4 as a second embodiment of the invention, in which the same (or similar) units as (or to) those in FIG. 1 denote the same reference numerals. FIGS. 5A and 5B are explanatory diagrams showing contents of the user information DB 12 in the alternative system in FIG. 4, and FIG. 6 illustrates a flowchart of a user registration process carried out in the alternative system in FIG. 4. As illustrated in FIGS. 5A and 5B, the user information DB 12 in the second embodiment does not contain a field “Invitee candidate”, as stated above, and the DB 12 contains a field “Reward” since the reward DB 17 in FIG. 1 has been merged with the DB 12.

A user registration process executed by the server system 1 shown in FIG. 4 will be explained with reference to the flowchart in FIG. 6, under the condition that the data in the DB is illustrated in FIG. 5A.

For example, it is assumed that the unregistered user C wishes to use the application provided by the server system 1 and accordingly accesses the server system 1 from the user terminal 2e. In response to the access, the user registration reception unit 11 of the server system 1 provides the user terminal 2c with an entry page to be used for user registration at Step S11. When the user C enters contact information of the user C on the entry page of the user terminal 2c, the user registration reception unit 11 carries out a search of the user information DB 12 to judge at Step S12 whether the user C of the terminal 2c is a registered user. In this example, since the user C is not registered, the operation, goes from Step S12 to Step S14, where the unit 11 registers the user C with contact information in the DB 12. Then the unit 11 renders the application providing unit 18 to provide the application (AP) to the user terminal 2c so that it is installed therein at Step 15. Then, by the function, of a program embedded in the application, a list of contact information of friends and so on registered in telephone/email directory of the user terminal 2c are automatically read out and forwarded to the contact information obtaining unit 15 at Step S16.

Next, at Step S17, the inviter candidate list generating/inviter specifying unit 14 compares the contact information of the friends and so on of the user C with the contact information of the registered users in the DB 12, to determine whether the list contains contact information of any registered users in the DB 12. If so, at Step S18, the unit 14 extracts the registered users who are identical to those in the list, generates an inviter candidate list on which the extracted registered users are contained, and forwards the list to the user terminal 2c so that the user C can select one of the registered users or more from the inviter candidate list. If the users A and B are contained in the contact information list obtained from the user terminal 2c, the inviter candidate list contains both of the users A and B, and if the user C selects the user A as an inviter from the inviter candidate list, the unit 14 registers the user A as the inviter of the user C at Step S19. FIG. 5B shows data of the DB 12 which has been updated after the registration procedure for the user C. It may be possible to allow a newly registered user to select no inviter and/or select plural or all inviters from the inviter candidate list. Then at Step S13, the registered contents of the user C are communicated to the terminal 2c for the confirmation.

When the user C of the user terminal 2c has been registered and the user A is identified and registered as the inviter of the user C, the reward management unit 16 updates reward of the user A stored in the DB 12 by adding an invitation reward to the current reward. It is possible to add the invitation reward when a predetermined condition(s) is satisfied, as stated with regard to the first embodiment in FIG. 1. It is also possible to give an invitee reward to the user C who has been registered. In the case that a plurality of invitees exist in the inviter candidate list and that a newly registered user is allowed to select two or more inviters (or all of the inviters) from the list, the invitation reward, that is to be given after a successful conclusion of the invitation, is divided among inviters selected by an invitee.

On the other hand, in the case that the user registration page is accessed by the user A of the terminal 2a (or the user B of the terminal 2b), the result of determination carried out at Step S12 indicates “YES,” because the user A (or B) has been registered, and therefore, the process proceeds from Step S12 to Step S13. At Step S13, the registered contents of the user A (or B) are communicated to the terminal 2a (or 2b) tor the confirmation. If necessary, the registered contents may be modified by the user A (or B).

In the case that the user registration page is accessed by the unregistered user D of the terminal 2d, the process proceeds from Step S12 via Steps S14-S16 to Step S17. If the contact information list obtained from the newly registered user does not contain any registered users in the DB 12, the procedure goes from Step S17 to Step S13, and terminates.

In each of the first and second embodiments illustrated in FIGS. 1 and 3, when the registration process is carried out within a platform, the association process based on user IDs of an inviter and an invitee is carried out. However, the operation process is not a prior-art automatic association process (automatic determination of an inviter and an invitee) that uses data in communication by mini-mail and/or chat, but an inviter is selected from an inviter candidate list by an invitee (or newly registered person) and specified and associated with the invitee.

In each of the first and second embodiments, if both of an inviter candidate and an invitee candidate use a SNS (social network service) such as Facebook® or the like, it is possible to associate them with each other by use of SNS IDs (by logging into Facebook®), instead of using mail addresses and telephone numbers. That is, in the case that an application uses Facebook® for user authentication, since a Facebook ID of the user can be obtained accordingly, the Facebook ID can be used for association. In a procedure thereof, Facebook® authentication of a registered user as an inviter is completed by carrying out a starting process of an application, and Facebook ID of the user is registered in the server system 1 in a similar manner to registration of a mail address and/or a telephone number. Then, when the application is launched by a newly registered user who is an invitee and authentication of the invitee in Facebook® is completed, all of the friend IDs of the invitee in Facebook® are obtained. A friend ID(s) included in the obtained friend IDs, that coincides with an ID(s) stored in the server system 1, is defined to be an inviter candidate(s) and displayed in a list on the newly registered user. That is, a Facebook ID is used instead of a mail address and a telephone number, and a friend list of Facebook is used instead of a telephone directory and a history.

Although the invention has been described in its preferred forms, it should be understood that various changes and modifications may be made in the invention without departing from the spirit and scope of the invention.

1. An application providing system for providing an application on a network, comprising a server system for providing a registered user as an inviter with a reward when an invitee is newly registered with the server system or starts using the application provided, wherein the server system comprises:
a storage unit for storing, in association with each of registered users of the application providing system, user information of invitee candidates of registered users, the user information including contact information of the invitee candidates;
a registration accepting unit for accepting registration of a new user;
a search unit for searching, when the registration of the new user has been accepted, whether user information of the new user exists in the storage unit as an invitee candidate, and, if so, searching registered users associated with the searched invitee candidate from the storage unit to set the searched registered users to be inviter candidates;
a list generation unit for generating a list of the inviter candidates obtained by the search unit, and supplying the inviter candidate list to a terminal of the new user;
an inviter specifying unit for specifying an inviter which has been selected from the inviter candidate list by the new user and transmitted from its terminal, and storing the inviter in the storage unit in association with the new user that is the invitee; and
a reward updating unit for updating a reward of the inviter specified by the inviter specifying unit, by adding a reward for a successfully concluded invitation to a previous reward of the inviter.

2. The application providing system according to claim 1, wherein the registration accepting unit of the server system further comprises:
means for providing the terminal of the new user with an entry page or box for entering an invitee candidate at the time of registration of the new user; and
means for associating the entered invitee candidate with the new user and storing in the storage unit, the entered invitee candidate in association with the new user.

3. The application providing system according to claim 1, wherein the server system further comprises:
contact information obtaining unit for obtaining contact information of users which are currently registered in the new user's terminal and/or contained in a communication history in the new user's terminal, when the application is installed in the new user's terminal, and storing in the storage unit, the obtained users with their contact information as invitee candidates of the new user.

4. The application providing system according to claim 1, wherein the server system further comprises an authentication unit adapted to authenticate a user, wherein the registration accepting unit is further adapted to display an entry page or box on the new user's terminal for entering an ID of an SNS, and the contact information obtaining unit is further adapted to operate in such a manner that if the SNS_ID is inputted and authenticated by the authentication unit, users having friend IDs associated with the SNS_ID and their contact information are obtained from the SNS, and the obtained users having the friend IDs with their contact information are stored in the storage unit as invitee candidates.

5. An application providing system for providing an application on a network, comprising a server system for providing a registered user as an inviter with a reward, wherein the server system comprises:
a storage unit for storing, in association with each of registered users of the application providing system, user information including at least one of mail address and telephone number of each registered user;
a registration accepting unit for accepting registration of a new user;
a contact information obtaining unit for obtaining from a registered user terminal, after the application is installed in the registered user terminal, a contact information list of users those are currently registered as friends in the registered user terminal, the contact information list containing email addresses or telephone numbers of the friends;
a searching unit for searching whether each of the friend users on the obtained contact information list has been registered as a registered user in the storage unit;
means for generating a list of inviter candidates in responding to the search result by the searching unit, if a friend user(s) on the contact information list has been registered as a registered user in the storage unit, wherein the inviter candidate list contains the friend user(s) that has been registered as a registered user(s) and contact information thereof, and supplying the inviter candidate list to the user terminal in which the application has been installed;
an inviter specifying unit for specifying an inviter which has been selected from the inviter candidate list by the user and transmitted from its terminal, and storing the inviter in the storage unit in association with the user who is the invitee; and
a reward updating unit for updating a reward of the inviter specified by the inviter specifying unit, by adding a reward for a successfully concluded introduction to a previous reward of the inviter, when the application is installed in the newly registered user terminal or the newly registered user satisfies the predetermined condition using the installed application.

6. The application providing system according to claim 5, wherein the contact information obtaining unit is further adapted to obtain, in addition to the first contact information list of the friend users currently registered in the user terminal when installing the application therein, a second contact information list of users contained in a communication history in the user terminal, and wherein the searching unit is adapted to search whether each of the friend users on the obtained first and second contact information lists has been registered as a registered user in the storage unit.

7. The application providing system according to claim 5, wherein the server system further comprises an authentication unit adapted to authenticate a user, and to display an entry box or page on the user terminal for entering an ID of an SNS, and the contact information obtaining unit is further adapted to process in such a manner that when the SNS_ID is inputted and authenticated by the authentication unit, users having friend IDs associated with the SNS_ID and their contact information are obtained from the SNS, and the obtained users having the friend IDs with their contact information are stored in the storage unit as inviter candidates.

8. The application providing system according to claim 5, wherein the predetermined condition for providing the inviter reward is an initial use or tutorial completion of the application after installing it.

9. A user terminal comprising the application provided by the server system of the application providing system according to claim 5, wherein the application comprises a computer program embedded therein, by which the contact information list of users those are currently registered as friends in the user terminal, is read out and forwarded from the user terminal to the contact information list obtaining unit of the server system.

10. A user terminal comprising the application provided by the server system of the application providing system according to claim 6, wherein the application comprises a computer program embedded therein, by which the contact information list of users those are currently registered as friends in the user terminal, is read out and forwarded from the user terminal to the contact information list obtaining unit of the server system.

11. A user terminal comprising the application provided by the server system of the application providing system according to claim 7, wherein the application comprises a computer program embedded therein, by which the contact information list of users those are currently registered as friends in the user terminal, is read out and forwarded from the user terminal to the contact information list obtaining unit of the server system.

12. A user terminal comprising the application provided by the server system of the application providing system according to claim 8, wherein the application comprises a computer program embedded therein, by which the contact information list of users those are currently registered as friends in the user terminal, is read out and forwarded from the user terminal to the contact information list obtaining unit of the server system.
